(19) United States
(12) Patent Application Publication
(10) Pub. No.: US 2004/0006691 A1
(43) Pub. Date: Jan. 8, 2004

(54) Keyless access control device

(75) Inventors: Eduard Bergmann, Ludenscheid (DE); Armin von Preetzmann, Castrop-Rauxel (DE)

Correspondence Address: BROOKS KUSHMAN P.C., 1000 TOWN CENTER, TWENTY-SECOND FLOOR, SOUTHFIELD, MI, 48075, US

(73) Assignee: Leopold Kostal GmbH & Co. KG, Ludenscheid (DE)

(21) Appl. No.: 10/601,443

(22) Filed: Jun. 23, 2003

Related U.S. Application Data
(63) Continuation of application No. PCT/EP02/01382, filed on Feb. 9, 2002.

(30) Foreign Application Priority Data
Feb. 15, 2001 (DE) 101 06 956.1
Aug. 2, 2001 (DE) 101 38 014.3

(51) Int. Cl. H04L 9/00

(52) U.S. Cl. 713/150

(57) ABSTRACT

A keyless authorized access control system includes object modules and an identification device. The identification device has a microprocessor and memory. The identification device and the object modules have respective communications links between them for communicating encoded data. The data is encoded using an encryption algorithm that is used to perform a symmetric encryption method which uses an encryption parameter respectively assigned to the object module. The memory of each identification device stores different encryption algorithms. The microprocessor of an identification device selects one of the stored encryption algorithms to be used for encoding the data to be communicated between the identification device and an object module. Instead of the identification device, one of the object modules may have the memory and selects one of the stored encryption algorithms to be used by the identification device for encoding the data communicated by the identification device and an object module.

### CROSS-REFERENCE TO RELATED APPLICATIONS

This is a continuation of International Application PCT/EP02/01382, published in German, with an international filing date of Feb. 9, 2002.

### BACKGROUND OF THE INVENTION

1. Field of the Invention

The present invention relates to a keyless authorized access control device having at least two object modules and at least one identification device in which the object modules and the identification devices have a bidirectional data communications link between them that can transfer encoded data. Each object module is assigned to a respective object. Each object module has a transceiver. Each identification device has at least one microprocessor. The data is encoded by an encryption algorithm and a symmetric encryption method using encryption parameters assigned to the respective object module.

The present invention also relates to an identification device and an object module for such a keyless authorized access control device.

2. Background Art

Keyless authorized access control devices are used where controlling access by means of a mechanical key is not desired. For example, such authorized access control devices are used in motor vehicles and in households. The intended opening of the respective object, for example the door of a motor vehicle or the garage door of a house, is done by the wireless transfer of a corresponding command together with an encoded record (herein “code”) from an identification device carried by a user to a transceiver assigned to the respective object.

If the transceiver associated with an object receives the code belonging to the object, the person carrying the identification device is considered to be authorized to have access, and access is enabled by triggering certain actuators to unlock the motor vehicle, for example. In order to make it unnecessary to carry several identification devices when several keyless authorized access control devices are used, identification devices and corresponding authorized access control devices have been developed which allow a single identification device to be used for an authorized access control query with several objects, for example the motor vehicle, the house, and possibly the work place.

The previously known devices, which allow authorized access control to be performed for several objects using a single identification device, work according to the principle that all the transceivers assigned to the objects work with the same encryption algorithm. Such devices are disclosed in DE 195 33 309 A1 and DE 196 07 017 C2, for example.

The object of DE 195 33 309 A1 involves composing the code that is transferred of a fixed code and a changing code both of which are sent together to open a motor vehicle. When such an authorized access control device is used, in order for it also to be possible to give identification devices to persons who may only open the house and not the motor vehicle, this authorized access control device has one or more other identification devices which transmit only one code which is the changing code.

The object of DE 196 07 017 C2 involves transferring data between each identification device and the transceivers assigned to the objects over a bidirectional data communications link, with the data being encoded by means of a symmetric encryption method. When this is done, the transferred data is encoded by means of an encryption algorithm that is used to perform the symmetric encryption method using certain encryption parameters. Each encryption parameter is a so-called encryption secret assigned to the addressed object. This device provides an adjustment of the encryption parameters between identification devices and the respective objects in a so-called learning mode.

A common characteristic of these known authorized access control or identification devices is that they use one and the same encryption algorithm for authorized access to different objects. The resulting low flexibility is a disadvantage, especially for objects which have a different life expectancy, such as motor vehicle and household objects. When one of the two objects is changed, it is not absolutely guaranteed that the new added object will work with the same encryption algorithm, so that the object module associated with the remaining object will probably also have to be changed. Especially when the number of objects is even greater, conflict is almost unavoidable when one of the objects is changed or when another object or identification device is added.

### SUMMARY OF THE INVENTION

By contrast, the device according to the present invention is more flexible at adapting to changing conditions, because from the start the device allows the use of at least two different encryption algorithms. In a first embodiment, this capability is provided in the identification device. In a second embodiment, this capability is provided in at least one of the object modules (preferably in the object module assigned to the object having the longest service life such as a household object).

This makes it possible, for example in the first embodiment when an object is changed, to select another encryption algorithm in the identification device for the new object module, or, if necessary, to replace an old encryption algorithm with a new one by reprogramming the identification device, without this affecting the other encryption algorithms implemented in the remaining object modules.

The second embodiment is especially advantageous in the case when a motor vehicle having an identification device is replaced with a new motor vehicle, for example, and thus at the same time the identification device belonging to the old vehicle is replaced by a new identification device belonging to the new vehicle. The new identification device works with a different encryption algorithm than the old identification device. In this case, if the encryption algorithm used by the new identification device is already present in the memory element of an object module, e.g. a household object module, this encryption algorithm is activated for the new identification device. Otherwise, it is stored in place of the old encryption algorithm that is no longer needed by reprogramming, without this interfering with other encryption algorithms affecting other identification devices.

### BRIEF DESCRIPTION OF THE DRAWINGS

The present invention is described below using a sample embodiment which refers to the attached figures:

FIG. 1 illustrates a block diagram of a first embodiment of a keyless authorized access control device according to the present invention; and

FIG. 2 illustrates an alternative to the identification device shown in FIG. 1.

### DETAILED DESCRIPTION OF THE PREFERRED EMBODIMENT(S)

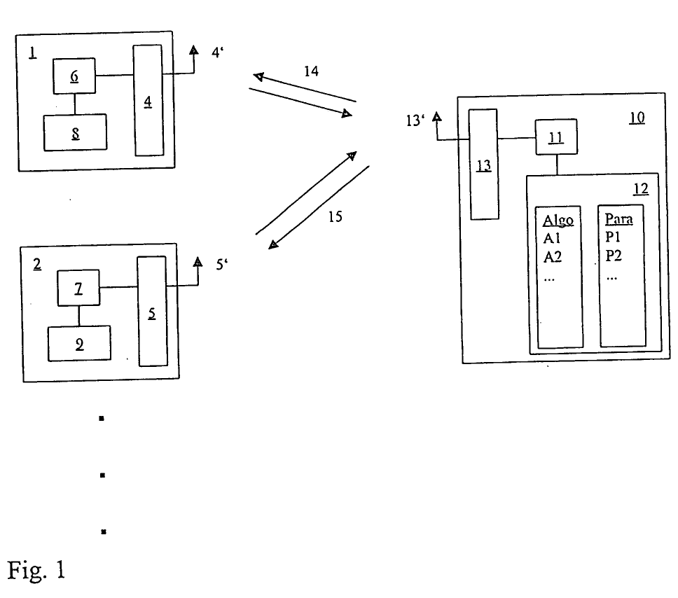

Referring now to FIG. 1, in a keyless authorized access control device, an identification device 10 gives a user authorized access to several objects. Identification device 10 contains the necessary means of electric transmission and reception 13 to communicate with transceivers 4, 5 of object modules 1, 2 assigned to respective objects, and thus to be able to exchange encoded data via bidirectional data communication links 14, 15 to establish authorized access. When this is done, the data is encoded both in identification device 10 and in object modules 1, 2 by microprocessors 11, 6, 7 using a symmetric encryption method, with identification device 10 and each addressed object module 1, 2 using the same encryption parameters P1, P2 to encrypt the data.

These encryption parameters represent the encryption secret between identification device 10 and each of object modules 1, 2. Identification device 10 has a separate set of encryption parameters P1, P2 for each object module 1, 2. Identification device 10 stores the encryption parameters P1, P2 in a memory element 12. The encryption parameters P1, P2 differ from one another. Each of the sets of encryption parameters P1, P2 can be changed in a known manner in coordination with both sides during the course of a data exchange between identification device 10 and object module 1, 2 which uses the respective set of parameters, in order to prevent the encryption secret being found out by spying.

In addition to encryption parameters P1, P2, identification device 10 also has stored in memory element 12 various commonly used encryption algorithms A1, A2, that are suitable for carrying out a symmetric encryption method. Each object module 1, 2 has a fixed encryption algorithm assigned to it, which is the one that respective object module 1, 2 also uses itself. The fixed assignment of the encryption algorithm for identification device 10 to use in reference to the respective object module occurs, so to speak, when the two devices become acquainted by a single initialization process. In contrast to encryption parameters P1, P2, the currently valid form of each of which is characteristic for the respective object module 1, 2, the encryption algorithms used by object modules 1, 2 do not necessarily differ from one another.

Thus it is entirely possible, e.g., for several object modules 1, 2 to use one and the same algorithm, perhaps A1, for example, while only a single object module N uses a different algorithm A2, or similar combinations. What is decisive is that identification device 10 stores a number of commonly used algorithms A1, A2, which can be called up by microprocessor 11 if they are needed, e.g., if a new object module is added. From the stock of encryption algorithms A1, A2, which are located in memory element 12 of identification device 10 it is also possible for individual, unnecessary algorithms to be replaced by newer ones through a programming interface without this affecting the algorithms that are still necessary for other object modules.

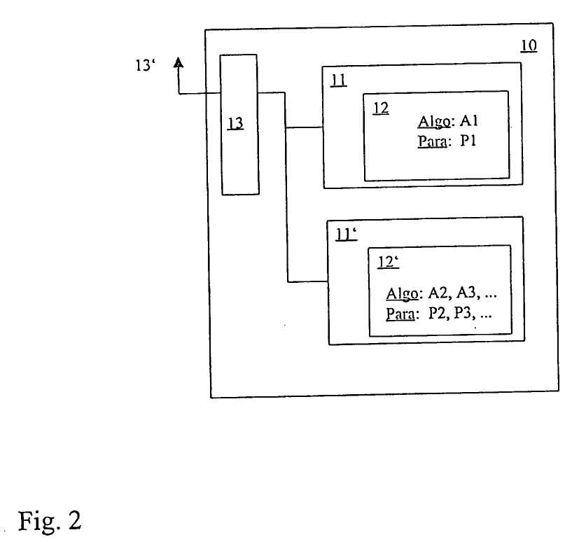

The alternative identification device 10 shown in FIG. 2 differs from the one shown in FIG. 1 in that here instead of only a single microprocessor 11 it provides for the use of two independent microprocessors 11 and 11′. Each microprocessor 11 and 11′ has directly integrated memory elements 12 and 12′. Of course, such integration of a memory element 12 in microprocessor 11 is also possible in identification device 10 shown in FIG. 1. However, the design shown in FIG. 2 has the advantage over it that the second microprocessor 11′, with the additional algorithms stored in its memory 12′, is hardware which is also completely exchangeable, if necessary, so that reprogramming is unnecessary even when an algorithm is supposed to be used which has not yet been provided for use. By contrast, the first microprocessor 11 with its memory 12 remains in identification device 10, so that its operation in connection with the object module(s) that are still being used is not affected by the exchange.

While the first embodiment of the keyless authorized access control device according to the present invention which has been described up to here assumes a universal identification device, so to speak, which can cooperate with several object modules using different encryption algorithms, the second embodiment of the present invention provides that at least one universal object module is present, which, for its part, can cooperate with several identification devices using different encryption algorithms. Of course, in a maximal configuration it is also possible to use both a universal identification device and universal object modules simultaneously.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A keyless authorized access control system, the system comprising:
at least two object modules, each object module being assigned to a respective object; and
at least one identification device, each identification device having a microprocessor and a memory element;
wherein each identification device and the object modules have respective bidirectional data communications links between them for communicating encoded data, the data communicated between an identification device and an object module being encoded using an encryption algorithm that performs a symmetric encryption method which uses an encryption parameter respectively assigned to the object module;
wherein the memory element of each identification device stores at least two different encryption algorithms, wherein the microprocessor of an identification device selects one of the stored encryption algorithms to be used for encoding the data to be communicated between the identification device and an object module.

2. The system of claim 1 wherein:
the encryption algorithm to be used for encoding the data to be communicated between the identification device and an object module is assigned by the identification device to the object module during a single initialization process between the identification device and the object module.

3. A keyless authorized access control system, the system comprising:
at least two object modules, each object module being assigned to a respective object, one of the object modules having a memory element; and
at least one identification device, wherein each identification device and the object modules have respective bidirectional data communications links between them for communicating encoded data, the data communicated between an identification device and an object module being encoded using an encryption algorithm performs a symmetric encryption method which uses an encryption parameter respectively assigned to the object module;
wherein the memory element of the one object module stores at least two different encryption algorithms, wherein the microprocessor of the one object module selects one of the stored encryption algorithms to be used by an identification device for encoding the data communicated by the identification device and an object module.

4. The system of claim 3 wherein:
the encryption algorithm to be used by the identification device for encoding the data communicated by the identification device and an object module is assigned by the one object module to the identification device during a single initialization process between the identification device and the one object module.

5. An identification device for a keyless authorized access control system having at least two object modules, each object module being assigned to a respective object, wherein the identification device and the object modules have respective bidirectional data communications links between them for communicating encoded data, the data communicated between the identification device and an object module being encoded using an encryption algorithm that is used to perform a symmetric encryption method which uses an encryption parameter respectively assigned to the object module, the identification device comprising:
a microprocessor and a memory element, wherein the memory element stores at least two different encryption algorithms, wherein the microprocessor selects one of the stored encryption algorithms to be used for encoding the data to be communicated with an object module.

6. The identification device of claim 5 wherein:
the encryption algorithms stored in the memory element are configurable and replaceable through a programming interface.

7. The identification device of claim 5 wherein:
the memory element is integrated in the microprocessor.

8. An object module for a keyless authorized access control system having an identification device and at least one other object module, each object module being assigned to a respective object, wherein the identification device and the object modules have respective bidirectional data communications links between them for communicating encoded data, the data communicated between the identification device and an object module being encoded using an encryption algorithm that is used to perform a symmetric encryption method which uses an encryption parameter respectively assigned to the object module, the object module comprising:
a microprocessor and a memory element, wherein the memory element stores at least two different encryption algorithms, wherein the microprocessor selects one of the stored encryption algorithms to be used by the identification device for encoding the data communicated by the identification device and one of the object modules.

9. The object module of claim 8 wherein:
the encryption algorithms stored in the memory element are configurable and replaceable through a programming interface.
